(19) United States
(12) Patent Application Publication
(10) Pub. No.: US 2005/0050482 A1
(43) Pub. Date: Mar. 3, 2005

(54) System and method for determining applicable configuration information for use in analysis of a computer aided design

(76) Inventors: S. Brandon Keller, Evans, CO (US); Gregory Dennis Rogers, Fort Collins, CO (US); George Harold Robbert, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/647,595

(22) Filed: Aug. 25, 2003

(51) Int. Cl. G06F 17/50

(52) U.S. Cl. 716/4

(57) ABSTRACT

Methods, systems and software products are described for determining applicable configuration information for use in analysis of a computer aided design. A state machine is generated using information contained in a plurality of configuration commands. A design element name, associated with a design element, is applied to the state machine. The state machine generates a list including configuration information applicable to the design element.

### RELATED APPLICATIONS

The present document contains material related to the material of copending, cofiled, U.S. patent application Ser. No. ______ Attorney Docket Number 100111221-1, entitled System And Method For Determining Wire Capacitance For A VLSI Circuit; Ser. No. ______ Attorney Docket Number 100111228-1, entitled Systems And Methods Utilizing Fast Analysis Information During Detailed Analysis Of A Circuit Design; Ser. No. ______ Attorney Docket Number 100111230-1, entitled Systems And Methods For Determining Activity Factors Of A Circuit Design; Ser. No. ______ Attorney Docket Number 100111232-1, entitled System And Method For Determining A Highest Level Signal Name In A Hierarchical VLSI Design; Ser. No. ______ Attorney Docket Number 100.11233-1, entitled System And Method For Determining Connectivity Of Nets In A Hierarchical Circuit Design; Ser. No. ______ Attorney Docket Number 100111234-1, entitled System And Method Analyzing Design Elements In Computer Aided Design Tools; Ser. No. ______ Attorney Docket Number 100111235-1, entitled System And Method For Determining Unmatched Design Elements In A, Computer-Automated Design; Ser. No. ______ Attorney Docket Number 100111236-1, entitled Computer Aided Design Systems And Methods With Reduced Memory Utilization; Ser. No. ______ Attorney Docket Number 100111238-1, entitled System And Method For Iteratively Traversing A Hierarchical Circuit Design; Ser. No. ______ Attorney Docket Number 100111257-1, entitled Systems And Methods For Establishing Data Model Consistency Of Computer Aided Design Tools; Ser. No. ______ Attorney Docket Number 100111259-1, entitled Systems And Methods For Identifying Data Sources Associated With A Circuit Design; and Ser. No. ______ Attorney Docket Number 100111260-1, entitled Systems And Methods For Performing Circuit Analysis On A Circuit Design, the disclosures of which are hereby incorporated herein by reference.

### BACKGROUND

An electronic computer aided design (“E-CAD”) tool is used to create a circuit design, including a very large scale integration (“VLSI”) circuit design. The circuit design includes a “netlist,” which defines a collection of nets specific to the circuit design. A “net” is a single electrical path in a circuit that has the same electrical characteristics at all of its points. For example, a collection of wires that carries the same signal between components is a net. If the components allow the signal to pass through unaltered (as in the case of a terminal), then the net continues on subsequently connected wires. If, however, the component modifies the signal (as in the case of a transistor or a logic gate), then the net terminates at that component and a new net begins on the other side. A “net name” identifies a particular net within the netlist.

E-CAD tools often require configuration information to properly analyze the circuit design. The configuration information includes “configuration commands” that are selectively applied to nets within the netlist. A configuration command is a function used to set an electrical characteristic of a component of the circuit design (hereinafter termed a ‘design element’). A design element represents a single component (e.g., transistor, wire, resistor, capacitor, diode, logic gate), a net, or a group of design elements structurally linked within the circuit design and processed by the E-CAD tool. Each configuration command may include, for example, a command type field, indicating the type of design element or circuit characteristic to which the command is applicable, a net name field, indicating the specific net to which the command is applicable, and a value field, indicating the value to which the named net is to be set. A configuration command might also, for example, contain only the command type field and value field, which are externally associated with a net name or design element name. These fields are applied to a design element to establish specific characteristics for that design element. For example, a configuration command ‘voltage VDD 2.1V’ may be used to set the supply voltage of a net named ‘VDD’ to 2.1 volts.

The E-CAD tool determines which configuration commands are applicable to particular nets in a VLSI design to expedite analysis of the circuit design. In order to determine which configuration commands are applicable to each net, “partial specifiers” are sometimes used to match net names within the netlist. A partial specifier is a “regular expression” used to identify and optionally select net names and design element names within the netlist. A regular expression is a source character string that defines pattern-matching and substitution operations on one or more destination character strings. The regular expression uses a set of ‘special’ characters such that the source character string matches specific parts of the destination character string. For example, the ‘.’ character in the source character string matches any one character in the destination character string, while the “*” character in the source character string matches zero or more consecutive characters in the destination character string. Examples of regular expressions can be found in many software tools (e.g., grep, awk, etc.) of the UNIX operating system. The partial specifier may be implemented only as a subset of the regular expression, for example the partial specifier incorporating only the searching functionality of the regular expression. The character strings “*/scan/shift”, “test/h1/*”, and “*” are examples of partial specifiers.

Prior art E-CAD tools employ several known methods to determine which configuration commands are applicable to nets of a circuit design. In one method, a partial specifier associated with a configuration command is used to match each net name in a netlist to determine if the configuration command applies to the net. This method requires a linear amount of time with respect to the number of partial specifiers being checked, and therefore is relatively time-consuming due to the fact that each net name in the netlist is checked against each partial specifier associated with each configuration command. Another method used to determine applicable configuration commands expands all of the partial specifiers at the outset of the analysis, thus pre-determining which nets match each configuration command. In a typical VLSI circuit design having millions of nets, both of these processes can be prohibitively lengthy, since they require M×N partial specifier matches, where M is the number of net names and N is the number of partial specifiers.

### SUMMARY

In one embodiment, a method determines applicable configuration information for use in analysis of a computer aided design. A state machine is generated using information contained in a plurality of configuration commands. A design element name, associated with a design element, is applied to the state machine. The state machine generates a list including configuration information applicable to the design element.

In another embodiment, a system determines applicable configuration information for use in analysis of a computer aided design. A file contains a plurality of configuration commands that sets values associated with nets in the design. A netlist contains a plurality of net names, each of which is associated with one of the nets. A processor executes a state machine that is compiled using information contained in a plurality of configuration commands. In response to input comprising one of the net names, the state machine generates a list including configuration information applicable to one of the nets corresponding to the input.

In another embodiment, a method determines applicable configuration information for use in analysis of a computer aided design. A state machine is generated using information contained in a plurality of configuration commands. In response to input including a net name associated with a net in the design, the state machine generates a list including the configuration information applicable to the net. The state machine is compiled by determining, from a set of regular expressions associated with the configuration commands, a set of, states and transitions between the states that are matched against characters of the net name to determine zero or more regular expressions that match the net name. Any of the regular expressions thus determined have associated therewith one or more corresponding configuration commands applicable to the net name. Each of the configuration commands includes a command type field indicating the type of entity to which the command is applicable, and a value field indicating the value to which the net corresponding to the net name is to be set. A net name, associated with the design, is applied to the state machine to generate the list. The configuration commands in the list are applied to at least one of the nets in the design.

In another embodiment, a system determines applicable configuration information for use in analysis of a computer aided design, including: means for generating a state machine using information contained in a plurality of configuration commands, wherein, in response to input comprising a design element name associated with a net in the design, the state machine generates a list including the configuration information applicable to the net; and means for applying the design element name to the state machine to generate the list.

In another embodiment, a software product has instructions, stored on computer-readable media, wherein the instructions, when executed by a computer, perform steps for determining applicable configuration information for use in analysis of a computer aided design, including: instructions for generating a state machine using information contained in a plurality of configuration commands, wherein, in response to input comprising a net name associated with a net in the design, the state machine generates a list including the configuration information applicable to the net; instructions for applying a net name, associated with the design, to the state machine to generate the list; and instructions for applying the configuration commands in the list to at least one net in the design.

### BRIEF DESCRIPTION OF THE DRAWINGS

FIG. 1 shows an exemplary E-CAD system for determining applicable configuration information for use in analysis of a computer aided design;

FIG. 2A is a flowchart illustrating an exemplary set of steps performed in operation of the system of FIG. 1;

FIG. 2B is a flowchart illustrating an alternate exemplary set of steps performed in operation of the system of FIG. 1;

FIG. 3 is a diagram of an exemplary state machine suitable for use in the system of FIG. 1; and

FIG. 4 is a flowchart illustrating one method for determining applicable configuration information for use in analysis of a computer aided design.

### DETAILED DESCRIPTION

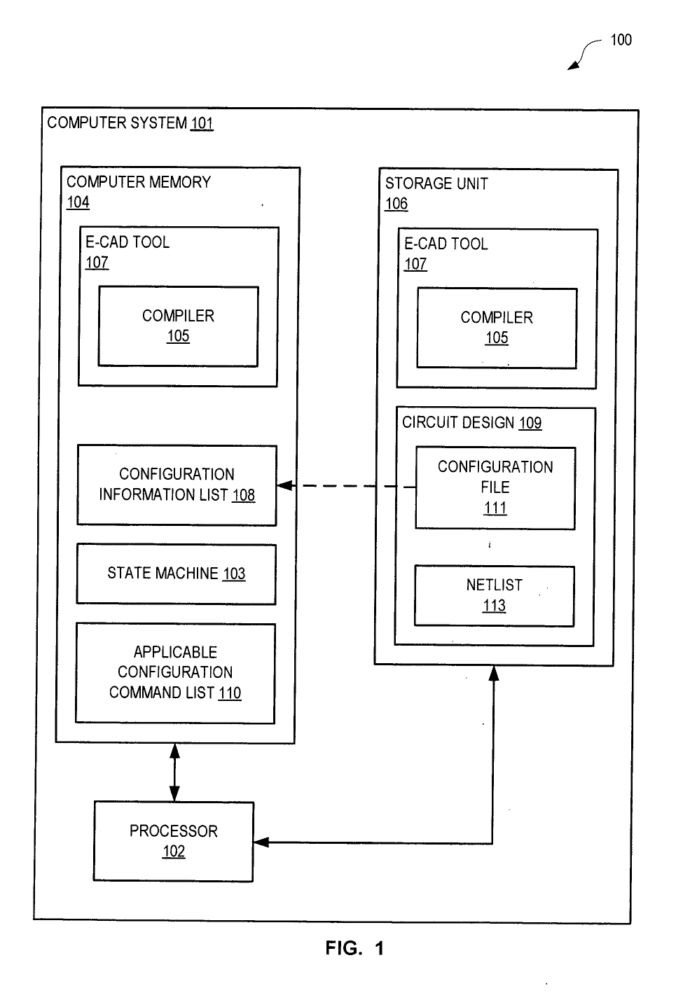

FIG. 1 shows an exemplary electronic computer aided design (“E-CAD”) system 100 that determines applicable configuration information for use in analysis of a computer aided design. System 100 includes a computer system 101, which contains a computer memory 104, a processor 102 and a storage unit 106. Storage unit 106 stores an E-CAD tool 107 and a circuit design 109. E-CAD tool 107 includes a compiler 105. Computer system 101 utilizes processor 102 to load E-CAD tool 107 and compiler 105 into computer memory 104 such that, upon execution by processor 102, E-CAD tool 107 analyzes circuit design 109. Circuit design 109 is for example developed by E-CAD tool 107; it includes a netlist 113, which defines the nets of circuit design 109, and a configuration file 111, which defines configuration commands for circuit design 109.

E-CAD tool 107 and compiler 105 are operable to generate a state machine 103 from partial specifiers contained in a configuration commands list 108 of configuration file 111. A “state machine” may be defined as a mechanism that has an initial state, and which includes a set of input events, a set of output events, a set of states, a function that maps states and input to output, and a function that maps states and inputs to states (called a state transition function). As described in more detail below, once generated, state machine 103 is operable to generate an applicable configuration command list 110 that contains configuration commands applicable to each net of interest during analysis of circuit design 109.

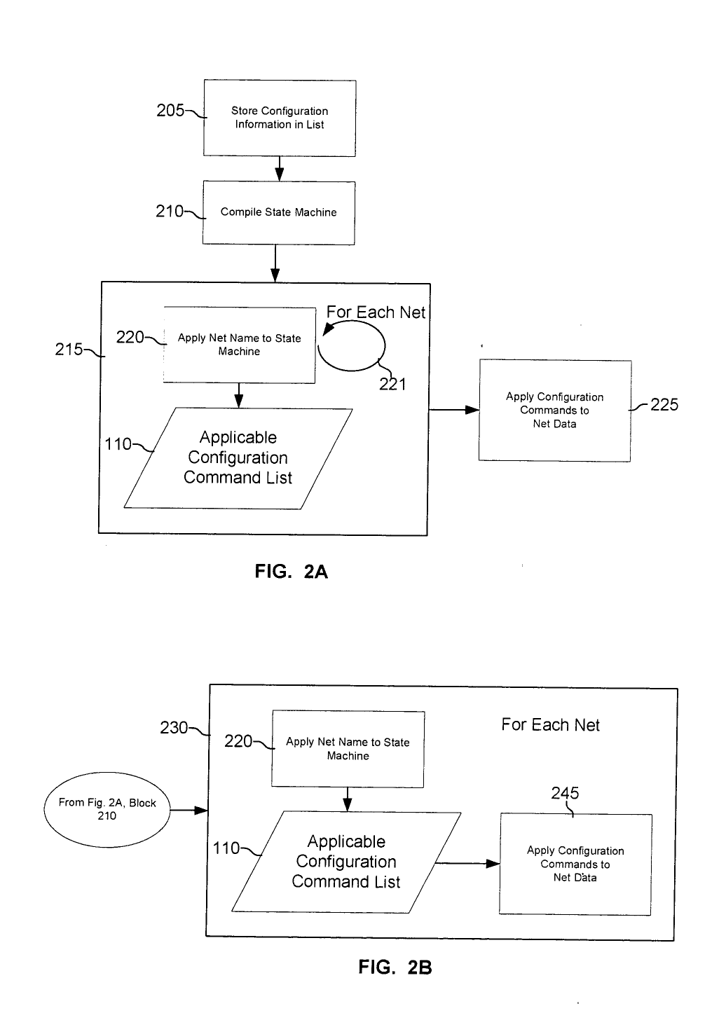

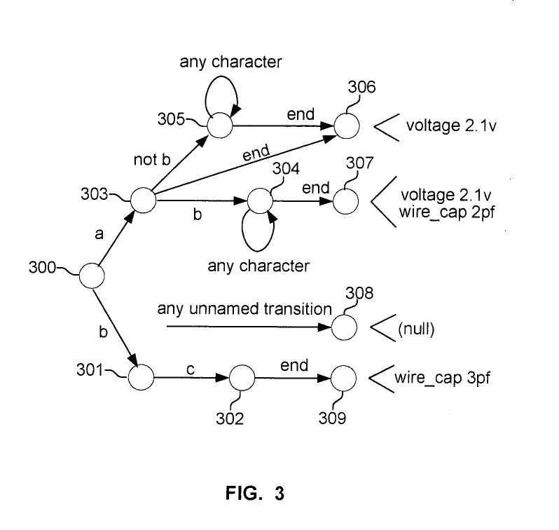

FIG. 2A is a flowchart illustrating an exemplary set of steps performed in operation of E-CAD system 100. FIG. 2B is a flowchart illustrating an alternative exemplary set of steps performed in operation of E-CAD system 100. FIG. 3 is a diagram of an exemplary state machine (e.g., state machine 103) used by E-CAD system 100. Operation of E-CAD system 100 is best understood by viewing FIG. 1, 2A, 2B and 3 in conjunction with one another. Initially, at step 205, information in configuration commands in configuration file 111, including the regular expression/net name associated with each command, is stored in configuration information list 108 in computer memory 104. In an alternative embodiment, configuration file 111 itself is loaded into computer memory 104 and the configuration command information contained therein directly referenced (in step 210) in lieu of list 108. An example of a partial list of configuration commands stored in configuration file 111 is shown below in Table 1, in which the ‘Command Type’ field indicates the characteristic associated with a specific net name that is to be set to the corresponding value:

TABLE 1
EXAMPLE CONFIGURATION COMMANDS

| Command Type | Net Name | Value | |
|---|---|---|---|
| voltage | a* | 2.1 v | # set supply voltage to 2.1 volt |
| wire_cap | ab* | 2 pf | # set wire capacitance to 2 pf |
| wire_cap | bc | 3 pf | # set wire capacitance to 3 pf |

At step 210, state machine 103 is compiled or otherwise generated from the configuration information stored in list 108, by using, in an exemplary embodiment, compiler 105. State machine 103 is generated from the set of partial specifiers associated with the configuration commands in configuration file 111. A set of states and transitions are determined such that, when state machine 103 is supplied with the characters of a net name (e.g., a net name of a net defined by netlist 113), state machine 103 determines which, if any, of the partial specifiers match the net name. From the partial specifiers, state machine 103 determines which, if any, of the associated configuration commands apply to the net name.

Methods for generating state machines are well known in the art, and the resulting state machine typically consists essentially of either a switch statement inside a loop, or a table that represents the possible transitions for each state as a function of a ‘current state’. In the former method, in each iteration of the loop, the switch statement uses the current state of state machine 103 to check a subsequent character of the net name being evaluated to decide which section of code to activate, where each code section is used to calculate the next state. The loop is iterated until the net name is completely matched and an ‘accepting state’ (e.g., states 306, 307, 308 and 309, FIG. 3) is reached. The accepting state defines configuration commands, if any, that are applicable to the matched net name and stores them in list 110. It should be noted that, in addition to net names, the present method is also applicable to other circuit design indicia, such as design element names.

In block 215, each net of interest in netlist 113 (all nets in design 109 are not necessarily of interest for every analysis) is processed by state machine 103 to generate list 110 containing applicable configuration commands, zero or more of which are applicable to a specific one of these nets. At step 220, a specific net name is applied to state machine 103, to generate list 110 of configuration commands applicable to the net name. FIG. 3 illustrates an exemplary state machine as generated by compiler 105 from the configuration commands of Table 1. State machine 103 is initially set to state 300, and advances from state to state based upon characters of the net name being analyzed. Assume that, in the present example, a net name of ‘abcd’ is applied to state machine 103. Upon reading the first character of the net name, state machine 103 transitions to state 303, since the first character in the net name is the character ‘a’. State machine 103 then determines if the end of the net name has been reached, and if not, it transitions from the current state to the next state based on the next character in the net name. In the example, the next character in the net name is ‘b’; therefore, state machine 103 transitions to state 304. State machine 103 then remains in state 304, processing the remaining character(s) of the net name using an ‘any character’ state transition (as shown), until all remaining characters of the net name (e.g., characters ‘c’ and ‘d’ of the example) are processed. Upon detecting the end of the net name, a transition is made to the accepting state 307 and applicable configuration commands resulting from state 307 are stored in list 110 (e.g., using the example of Table 1, configuration commands ‘voltage abcd 2.1v’ and ‘wire_cap abcd 2pf’ are stored in list 110, indicating that the supply voltage for net ‘abcd’ is 2.1 volts, and that the wire capacitance for net ‘abcd’ is 2 picoFarads).

Note that this result is consistent with the fact that the string ‘abcd’ is matched by the partial specifier ‘a*’ of configuration command ‘voltage a*2.1v’, and also by the partial specifier ‘ab*’ of configuration command ‘wire_cap ab*2pf’.

In a similar manner, processing of the net name ‘bc’ by state machine 103 results in transitions from state 300 through state 302, to accepting state 309. The configuration command ‘wire_cap bc 3pf’ is then stored in list 110.

Any unnamed transition encountered in processing the net name results in a transition to a null accepting state 308. For example, if the net name ‘ba’ is applied to state machine 103, an initial transition occurs from state 300 to state 301 in response to the first character ‘b’ in the net name. Processing of the next character, a′ of the net name, results in a transition to state 308, since the only named transition from state 301 is in response to the character ‘c’; the net name ‘ba’ is therefore non-matching. Since state 308 has a null configuration command, no entry would be stored in list 110 for the net name.

Step 220 in block 215 is then repeated for each net of interest in design 109, as indicated by arrow 221. After the applicable configuration commands have been generated for all nets of interest, then at step 225, the configuration commands in list 110 are applied to the appropriate nets in design 109 using E-CAD tool 107.

FIG. 2B is a flowchart illustrating an alternative exemplary set of steps performed in operation of system 100, FIG. 1. As shown in FIG. 2B, after performing steps 205 and 210, each net of interest in netlist 113 is applied to state machine 103 to generate list 110 of configuration commands specific to a particular net, at step 220, as described above with respect to in FIG. 2A. In the present embodiment, each step in block 230 is performed for one net at a time. When a net has been processed in step 220, the configuration command or commands corresponding to the accepting state for this net are stored in list 110. After the applicable configuration commands have been generated for the present net of interest in design 109, then at step 245, the configuration commands in list 110 are applied to the present net using E-CAD tool 107. The steps in block 230 are then repeated for each net of interest in design 109.

Instructions that perform the operations described with respect to FIG. 2A and FIG. 2B may be stored in computer memory 104 or other computer-readable media, and later retrieved therefrom and executed by processor 102 to operate in accordance with the present system. Examples of instructions include software, program code, and firmware. Examples of storage media include memory devices, tapes, disks, integrated circuits, and servers.

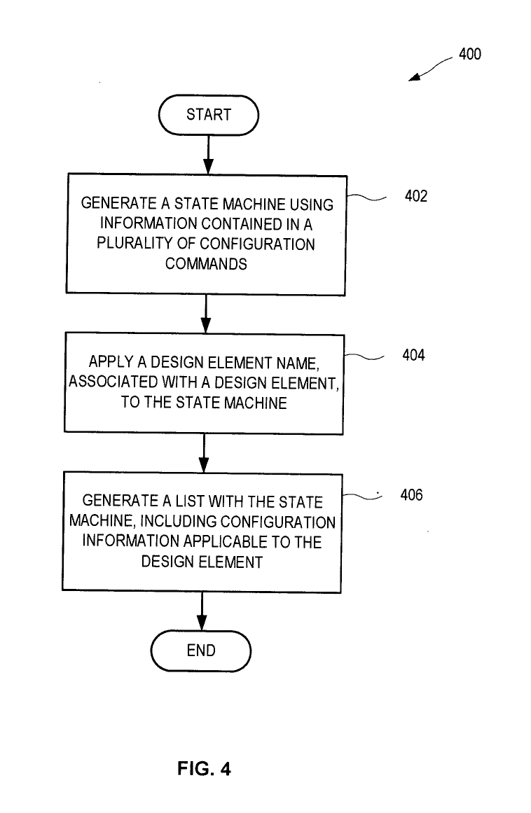

FIG. 4 is a flowchart illustrating one process 400 for determining applicable configuration information for use in analysis of a computer aided design. In step 402, a state machine is generated using information contained in a plurality of configuration commands. In step 404, a design element name, associated with a design element, is applied to the state machine. In step 406, the state machine generates a list including configuration information applicable to the design element. Process 400 is for example executed by system 100, FIG. 1 during analysis of design 109.

Changes may be made in the above method and system without departing from the scope hereof. It should thus be noted that that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

1. A method for determining applicable configuration information for use in analysis of a computer aided design, comprising:
generating a state machine using information contained in a plurality of configuration commands;
applying a design element name, associated with a design element, to the state machine; and
generating with the state machine a list including configuration information applicable to the design element.

2. The method of claim 1, wherein the state machine is compiled by determining, from a set of regular expressions associated with the configuration commands, a set of states and transitions between the states that are matched against characters of the design element name to determine zero or more regular expressions that match the design element name, wherein any of the regular expressions have associated therewith one or more corresponding configuration commands applicable to the design element name.

3. The method of claim 1, wherein the design element name is associated with a net in the design.

4. The method of claim 3, wherein the state machine generates the list by evaluating regular expressions, associated with each net of interest in the design, to determine an accepting state for each of the regular expressions, wherein each accepting state has associated therewith one or more corresponding ones of the configuration commands applicable to net names in the design.

5. The method of claim 4, wherein each of the configuration commands includes a command type field indicating the characteristic to which the command is applicable, and a value field indicating the value to which the design element corresponding to the design element name is to be set.

6. The method of claim 5, wherein each of the configuration commands further includes a net name field comprising a regular expression indicating at least one specific net in the design to which a corresponding one of the configuration commands is applicable.

7. The method of claim 1, including the step of applying the configuration commands to at least one net in the design, wherein the design element name is associated with the net.

8. The method of claim 1, wherein the design element name is a net name contained in a netlist associated with the design.

9. A system for determining applicable configuration information for use in analysis of a computer aided design, comprising:
a file containing a plurality of configuration commands for setting values associated with nets in the design;
a netlist containing a plurality of net names, each of which is associated with one of the nets;
a processor; and
a state machine, executed by the processor, that is compiled using information contained in a plurality of configuration commands, wherein, in response to input comprising one of the net names, the state machine generates a list including configuration information applicable to one of the nets corresponding to the input.

10. The system of claim 9, wherein the state machine is compiled by determining, from a set of regular expressions associated with the configuration commands, a set of states and transitions between the states that are matched against characters of a net name to determine zero or more regular expressions that match the net name, wherein any of the regular expressions thus determined have associated therewith one or more corresponding ones of the configuration commands applicable to the net name.

11. The system of claim 10, wherein each of the configuration commands includes a command type field indicating a characteristic to which the command is applicable, and a value field indicating the value to which the net corresponding to the net name is to be set.

12. The system of claim 11, wherein each of the configuration commands further includes a net name field indicating a specific net to which a corresponding one of the configuration commands is applicable.

13. A method for determining applicable configuration information for use in analysis of a computer aided design, comprising:
generating a state machine using information contained in a plurality of configuration commands, wherein, in response to input comprising a net name associated with a net in the design, the state machine generates a list including configuration information applicable to the net;
wherein the state machine is compiled by determining, from a set of regular expressions associated with the configuration commands, a set of states and transitions between the states that are matched against characters of the net name to determine zero or more regular expressions that match the net name, wherein any of the regular expressions thus determined have associated therewith one or more corresponding configuration commands applicable to the net name;
wherein each of the configuration commands includes a command type field indicating the type of entity to which the command is applicable, and a value field indicating the value to which the net corresponding to the net name is to be set;
applying a net name, associated with the design, to the state machine to generate the list; and
applying the configuration commands in the list to at least one of the nets in the design.

14. The method of claim 13, wherein each of the configuration commands further includes a net name field indicating a specific net in the design to which a corresponding one of the configuration commands is applicable.

15. A system for determining applicable configuration information for use in analysis of a computer aided design, comprising:
means for generating a state machine using information contained in a plurality of configuration commands, wherein, in response to input comprising a design element name associated with a net in the design, the state machine generates a list including the configuration information applicable to the net; and
means for applying the design element name to the state machine to generate the list.

16. The system of claim 15, wherein each of the configuration commands includes a command type field indicating the type of entity to which the command is applicable and a value field indicating the value to which the design element corresponding to the design element name is to be set, and wherein the state machine is compiled by determining, from a set of regular expressions associated with the configuration commands, a set of states and transitions between the states that are matched against characters of the design element name to determine zero or more regular expressions that match the net name, wherein any of the regular expressions thus determined have associated therewith one or more corresponding configuration commands applicable to the design element name.

17. The system of claim 16, wherein each of the configuration commands further includes a net name field indicating a specific net to which a corresponding one of the configuration commands is applicable.

18. A software product comprising instructions, stored on computer-readable media, wherein the instructions, when executed by a computer, perform steps for determining applicable configuration information for use in analysis of a computer aided design, comprising:
instructions for generating a state machine using information contained in a plurality of configuration commands, wherein, in response to input comprising a net name associated with a net in the design, the state machine generates a list including the configuration information applicable to the net;
instructions for applying a net name, associated with the design, to the state machine to generate the list; and
instructions for applying the configuration commands in the list to at least one net in the design.

19. The software product of claim 18, wherein the instructions for generating the state machine cause the state machine to be compiled by determining, from a set of regular expressions associated with the configuration commands, a set of states and transitions between the states that are matched against characters of the net name to determine zero or more regular expressions that match the net name, wherein any regular expressions thus determined have associated therewith one or more corresponding configuration commands applicable to the net name.

20. The software product of claim 18, wherein the instructions for generating the state machine cause the configuration commands to be applied to at least one net in the design.
